(19) United States
(12) Patent Application Publication
(10) Pub. No.: US 2004/0032748 A1
(43) Pub. Date: Feb. 19, 2004

(54) Illuminating structure

(76) Inventors: Gilles Trudeau, Chambly (CA); Patrick Lauziere, Montreal (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/217,473

(22) Filed: Aug. 14, 2002

(51) Int. Cl. F21V 7/04

(52) U.S. Cl. 362/554; 362/559; 362/558

(57) ABSTRACT

The invention relates to an illuminating structure in which one or more optical wave guides, such as optical fibers, are embedded in a hardened material, the material having hardened with the fibers or guide embedded therein. Visible from the surface of the illuminating structure (for example, flush with, recessed within, or protuberant from the surface), the end of each optical fiber or guide is exposed, or a light diffuser is positioned at the end of a fiber so that when a light source is applied to the optical fiber, the surface of the illuminating structure is illuminated. The structure may be used as, for example, a floor tile, a road sign, or a side portion of a swimming pool. Advantageously, the illuminating structure is resilient and can withstand applications of weight and abrasion.

### FIELD OF THE INVENTION

The present invention relates generally to illuminating structures.

### BACKGROUND OF THE INVENTION

Normally, encased illuminating structures have a light source powered by an energy source and held by a support frame.

The light source is often located inside the support frame, as in the case of a flashlight, illuminated watch, or table lamp. Illuminating structures have an internal energy source, such as a battery, or an external one, such as an electrical outlet. The support frame may be the plastic mould of a flashlight, the glass ball of a ceiling lamp, or the casing of halogen lamp.

Traditionally support frames of illuminating structures are hollow. U.S. Pat. No. 6,024,476 describes an illuminated sign whose letters are lit at the back by optical fibers distributing light from a light source. A disadvantage includes room available for the undesirable growth of plants. The illuminated brick of U.S. Pat. No. 2,120,553 also features a hollow support frame. Structurally weak due to its hollow support frame, the brick would not withstanding large applications of local or distributed forces. The weight of a vehicle such as a car or plane would crush or damage the illuminated brick.

Illuminating structures that are not hollow have support frames filled with structurally weak material that are not weather resistant. The illuminated headboard of U.S. Pat. No. 6,256,811 provides optical fibers arranged at the headboard surface to depict an illuminated starlight scene and embedded in a rigid material. Similarly, light emitting diodes embedded in epoxy is also known to those in the art. Due to the use of weak material in the support frame, these illuminating structures may be deformed or crushed by large forces.

Ornamental lamps having optical fibers are often damaged when the lamp surface is worn out. Most have fibers whose light radiates along their lengths, illuminating the ornamental shape of the lamp and its vicinity. The illumination provided by a lamp, such as that disclosed in U.S. Pat. No. 1,218,049, would likely change if the surface of the support frame was worn away by weather conditions, such as rain, hail, snow, or abrasion. Scratching the illuminating structure, chipping the surface, walking and driving on the surface wear away the surface of the structure.

It is, therefore, desirable to provide an illuminating structure having a support frame which is not hollow, which is composed of a robust material, and which has a surface that can be worn away while providing similar illumination.

### SUMMARY OF THE INVENTION

It is an object of the present invention to obviate or mitigate at least one disadvantage of previous illuminating structures.

Advantageously, the structure according to the invention can withstand forces such as weight, friction, abrasion, and inclement weather.

Accordingly, the invention provides an illuminating structure comprising a hardened substrate, having at least one surface and an optical wave guide positioned therein, through which light is transported. The optical wave guide is embedded in the hardened substrate and has a distal end terminating visibly at the surface of the hardened substrate so that light transported through the wave guide is visible on the surface.

Additionally, the invention provides an illuminating structure comprising a hardened substrate, an optical fiber and a light diffuser. The hardened substrate has at least one surface. The optical fiber is capable of transporting light, and is embedded in the hardened substrate. The light diffuser is located at a distal end terminal end of a fiber, and is visible at the surface of the hardened substrate so that light transported through the fiber is diffused through the light diffuser and is visible on the surface of the hardened substrate.

Further, the invention provides a method of constructing an illuminating comprising the following steps: (a) holding an optical wave guide in a pre-determined position within a mould; (b) pouring a flowing hardenable substrate into the mould to cover a portion of the wave guide while leaving an end of the wave guide exposed to a surface of the mould; and (c) allowing the substrate to harden.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures.

FIG. 1 illustrates an illuminating structure according to an embodiment of the invention.

FIG. 2 illustrates an illuminating structure having an internal power source according to an embodiment of the invention.

FIG. 3 illustrates an illuminating structure having an external power source according to an embodiment of the invention.

FIG. 4 illustrates an illuminating structure having a solar cell according to an embodiment of the invention.

FIG. 5 illustrates an illuminating structure having a solar cell according to an embodiment of the invention.

FIG. 6 illustrates an illuminating structure in the form of a tile according to an embodiment of the invention.

FIG. 7 illustrates an exemplary illuminating structure in the form of a sign.

FIG. 8 illustrates a swimming pool having an illuminating structure formed therein according to an embodiment of the invention.

FIG. 9 illustrates a side view in section of an illuminating tile according to an embodiment of the invention.

FIG. 10 illustrates a schematic view of an illuminating tile with an arrow pattern thereon according to an embodiment of the invention. The tile has an optical connector for connection with an external light source.

FIG. 11 illustrates a solar-powered illuminating tile having a pattern of a cartoon character's face illuminated on the surface thereof, according to an embodiment of the invention.

FIG. 12 illustrates a light source embedded in a cavity of a concrete illuminating tile according to an embodiment of the invention, showing optical fibers embedded in the tile.

FIG. 13 shows a structure according to the invention having a light source embedded in a flexible irregularly shaped strip.

### DETAILED DESCRIPTION

Generally, the present invention provides an illuminating structure and method for forming an illuminating structure. Advantageously, the illuminating structure of the present invention is capable of withstanding forces such as weight, friction, and inclement weather, and thus is suitable for a variety of uses both indoors and outdoors. One of skill in the art will appreciate that a number of embodiments are possible, beyond the specific examples described herein.

An illuminating structure according to the invention comprises a hardened substrate, having at least one surface, and an optical wave guide through which light is transported. In preferred embodiments, the optical wave guide comprises an optical fiber, or an optical fiber including a light diffuser at the distal terminal end thereof. Another type of optical wave guide which may be used with the invention is one or more light pipes. Any wave guide capable of transmitting light to its distal terminal would fall within the scope of the optical wave guide according to the invention. In the case where the wave guide is an optical fiber (with or without the diffuser), the fiber is embedded in the hardened substrate and has a distal end terminating visibly from the surface of the hardened substrate so that light transported through the fiber is visible on the surface.

By “terminating visibly” or “visibly terminated”, it is meant that the light departing the distal terminal end of the fiber is visible (optionally through the light diffuser) from the surface of the substrate. Thus, it may be terminated flush with the surface, recessed within the surface, or protuberant from the surface. In the case where the distal terminal end is recessed within the surface, the surface itself may have a beveled recess leading inward to emphasize the lighted visible terminal end, or the recess in the surface may have sides normal to the surface.

For ease of reference, optical fibers and optical wave guides are referred to herein as having two terminal ends. One end of the fiber or guide is referred to as the “distal end” meaning located away from the light source, and the other end of the fiber or guide is referred to as the “proximal end” meaning located near to, adjacent to, or in the proximity of the light source.

The illuminating structure becomes illuminated through application of light via a light source located at the proximal terminal end of the fiber or guide. Thus, according to an embodiment of the invention, the illuminating structure further includes a light source for illuminating the optical fiber or guide. However, it is not required that the structure have a light source included therein, as such light sources as are known in the art can be easily applied to the inventive tile after its manufacture.

The illuminating structure of the invention may further including a power source for powering the light source. Of course, it would not be necessary to include a power source at the time of manufacture, as those of skill in the art would understand that any type of conventional power source could be applied to ensure that light can be formed from the light source. In an embodiment where the power source is included within the illuminating structure, the power source may in fact be embedded within in the hardened substrate, or housed within a cavity formed in the substrate. As exemplary power sources, a battery or a solar cell may be used. Additionally, such power sources as are known in the art can be assembled with the light source to power the light source externally or internally to the structure (within a cavity, envelope, or enclosure) after the structure is manufactured. The light source and power source may be separate or combined. One or both of these may be external to the illuminating structure.

The control of the light source may be external to the source itself. For example, such controls may include on/off switches, remote controls, a dimmer, various color controls, color combinations, color changing effects, timers, pre-set “moods”, automatic on/off according to ambient light conditions, or motion sensor controls. Any control capable of utilization with lighting of other types can be incorporated with the invention. A color controller may additionally be added as a separate device either remote to or included within the illuminating structure.

In the embodiment where the light source is included in the illuminating structure, it may be embedded in the hardened substrate, or may optionally be provided within a cavity or an enclosure formed within the hardened substrate. As a further option, such a cavity or enclosure may house either or both the light source and/or a power source therefor.

For use with the invention, the light source may be selected from any conventional type of light source adaptable for use in transmitting light into an optical fiber or wave guide. Such a light source may, for example, be an incandescent light bulb, a halogen bulb, a fluorescent tube, or a light emitting diode. The light source may be connected to the fibers through any type of connector or light coupling as would be used in the art.

The optical wave guide may be any type of guide capable of transmitting light along its length. Preferably, the wave guide comprises an optical fiber, and in one variation, the optical fiber may have a light diffuser positioned at the distal end thereof so as to diffuse the light emerging from the fiber itself to create a desired effect, as described below. The optical wave guide may alternatively comprise a light pipe, or any other light guiding device capable of being embedded in a hardened substrate.

In one embodiment of the invention, wherein the wave guide is an optical fiber, the fiber may include within its structure (at its distal end), or may be operatively connected to a light diffuser. In such an embodiment, the light diffuser may terminate flush with the surface of the hardened substrate, so as to create a diffused light effect at the illuminated surface of the hardened substrate.

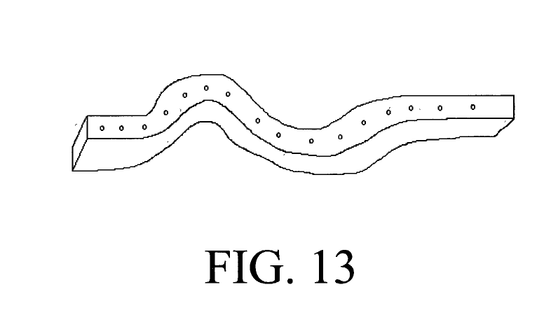

The illuminating structure may be formed of any hardened substrate capable of flowing into a mould in its non-hardened form. For example, such a substrate may be concrete, cement, epoxy, silicon (soft silica), a natural or synthetic polymer, or mixtures of these. By “hardened” it is meant that the substrate changes from a flowing and malleable state to a non-flowing resilient state. In many of the embodiments of the invention, the substrate may be flowable in a fluid-type format, such as cement, and then hardened into a solid state. However, for some substrates, such as soft silica, the substrate may be applied into a mould in a malleable state (for example, “blown” into the mold), and then hardens into a resilient state, which may be spongy, or deformable, provided the original shape of the hardened structure is recovered after pressure is applied. When substrates are used that do not harden into a fully solidified state (for example, capable of supporting the weight of a large vehicle), such structures never-the-less fall within the scope of the invention, but may have different advantages. For example, hardened substrates which are resilient and yet remain flexible (such as silicon) can be used for various purposes aside from for use under foot or under a vehicle, for example as decoration, or as an outdoor structure with a certain degree of durability to weather conditions. An example of such a flexible resilient structure is discussed below with reference to FIG. 13.

At minimum, for embodiments having an optical fiber, the illuminating structure has one optical fiber embedded therein. Of course, a plurality of optical fibers may be used having a distal end terminating flush with the surface of the hardened substrate. A combination of fibers with and without light diffusers located at the distal terminal ends thereof may be used. Fibers may be used with a single fiber exposed to the surface of the structure, or with a fiber bundle exposed at an illumination point. Different colors of light may be applied to different fibers so as to create a multi-colored effect. Additionally, different strengths of light may be applied to different fibers so as to create different degrees of illumination at the surface of the structure.

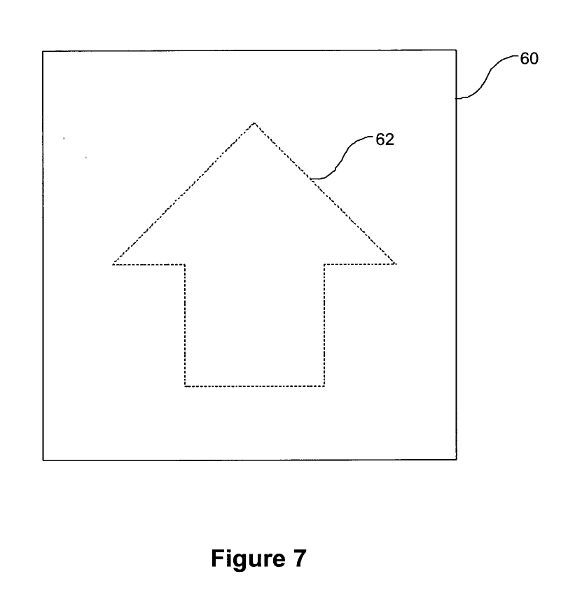

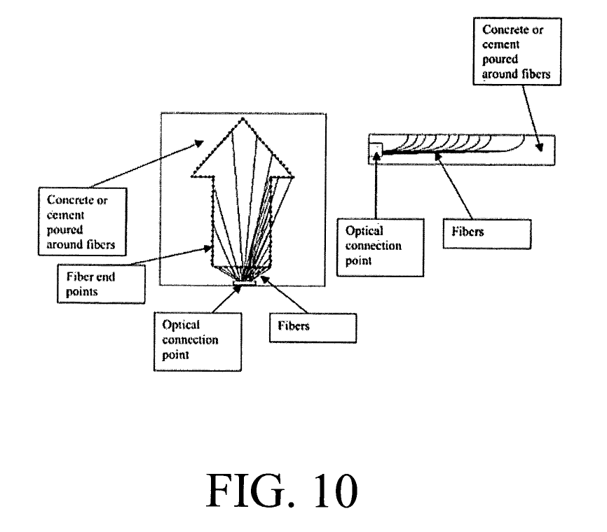

The distal ends of the fibers (or other optical wave guides, where applicable) within the illuminating structure may be arranged to form a pattern at the surface of the hardened substrate. Such a pattern can be pre-determined so that an appropriate appearance to the surface of the structure may be achieved. Any variety of patterns may be chosen, such as for example those representing numbers, letters, directions, pictures, cartoon representations, random patterns or ornamental patterns. The depiction of an arrow pattern is shown later in FIGS. 7 and 10, which is only used herein for ease of reference, and should in no way be considered limiting.

The illuminating structure of the invention is useful in a variety of applications. For example, the illuminating structure may form a tile, a sign, or a portion of a swimming pool. Any conventional structure formed of a flowable substance such as cement, epoxy or concrete may be adapted according to the invention by forming the structure at the time of pouring the hardenable substrate.

The invention provides an illuminating structure comprising a hardened substrate, an optical fiber, and a light diffuser. The light diffuser may be considered as part of the optical fiber, or may be considered as a separate component. In this case, the hardened substrate, having at least one surface thereon, has an optical fiber through which light is transported, the fiber being embedded in the hardened substrate. A light diffuser located at a distal end terminal end of the fiber, the light diffuser being flush with the surface of the hardened substrate so that light transported through the fiber is diffused through the light diffuser and is visible on the surface of the hardened substrate.

The invention also relates to a method of constructing an illuminating structure. The method comprises the steps of: (a) holding an optical fiber in a pre-determined position within a mould; (b) pouring a flowing hardenable substrate into the mould to cover a portion of the fiber while leaving an end of the fiber exposed to a surface of the mould; and (c) allowing the substrate to harden.

The invention may include the optional step of truncating the fiber so that the portion of the fiber exposed at a surface of the mould is flush with the surface. The method step of truncating may involve exposing a surface of the substrate, once hardened, to a grinder. The step of holding an optical fiber in a pre-determined position may comprise aligning the distal ends of a plurality of fibers with a stencil having holes located therein to form a pre-determined pattern.

In the method of the invention, the flowing hardenable substrate may be concrete, cement, or epoxy.

The method may further including, prior to the step of pouring, the step of forming a cavity within the mould disposed at a proximal end of the optical fiber. Further, the method may also include, after allowing the substrate to harden, the step of connecting a light source to the fiber at a proximal end of the fiber. The method may additionally include, after the step of hardening, the step of storing light source and a power source are stored within the cavity.

The optical fiber may comprise a light diffuser disposed thereon, located flush with the surface of the mould. In this case, the light diffuser can be included within the mould prior to pouring the mould or alternatively, a cavity for housing a light diffuser may be incorporated into the mould so that once the structure is hardened, the light diffuser may then be added on. Of course, in the case where the fiber and the light diffuser are composite, the light diffuser would be included at the time the mould is poured.

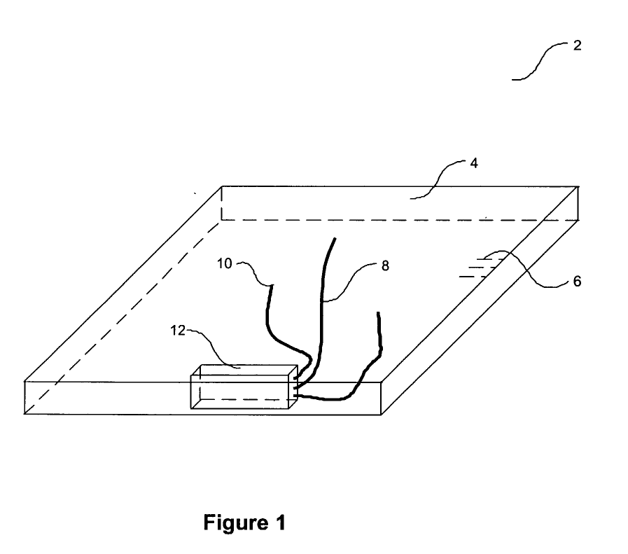

As described earlier, traditional illuminating structures do not include a hard substrate. FIG. 1 illustrates the principle of the present invention. An illuminating structure (2) includes a hardened substrate (4) having at least one surface (6) and an optical fiber (8) through which light is transported. The hardening substrate consists of concrete, cement or epoxy. One of skill in the art will appreciate that a number of hardening substrates are possible.

One end of the optical fiber terminates flush with a surface (6) of the substrate. Optionally included in the illuminating structure is a light source (12) for illuminating the optical fiber. Although not expressly shown in the drawings, the use of an incandescent light bulb, a halogen bulb, a fluorescent tube or a light emitting diode as a light source is also envisaged. As will be appreciated by those of skill in the art, additional fibers and/or other light sources can be embedded to provide, for example, more lighting.

In another embodiment of the present invention, the illuminating structure includes at least two light sources producing different colors of light for illuminating different optical fibers.

One of skill in the art will appreciate that light diffusers may be incorporated with the ends of the optical fibers for diffusing light at the surface of the hardening material.

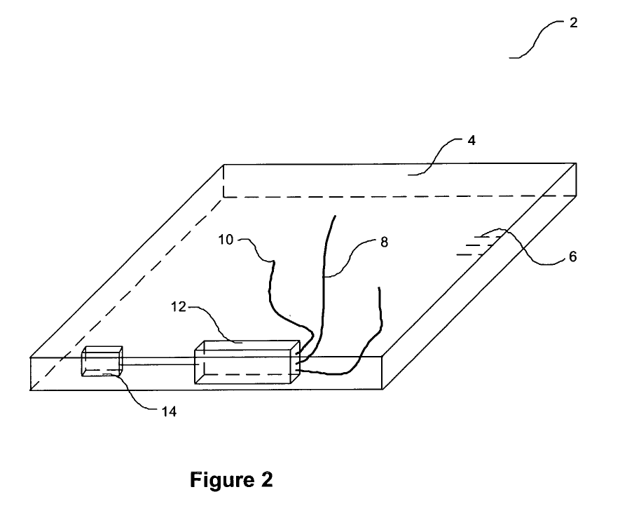

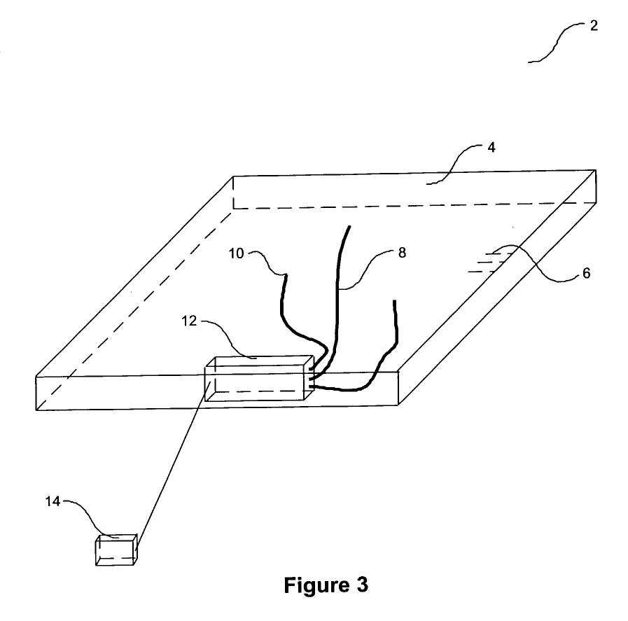

FIG. 2 illustrates a further exemplary embodiment of an illuminating structure according to the invention. In this example, the structure includes a power source (14) embedded inside the structure. FIG. 3 illustrates an alternate embodiment in which the light source (12) is powered by a power source (14) external to the structure. For exemplary purposes, the power source can consist of a battery.

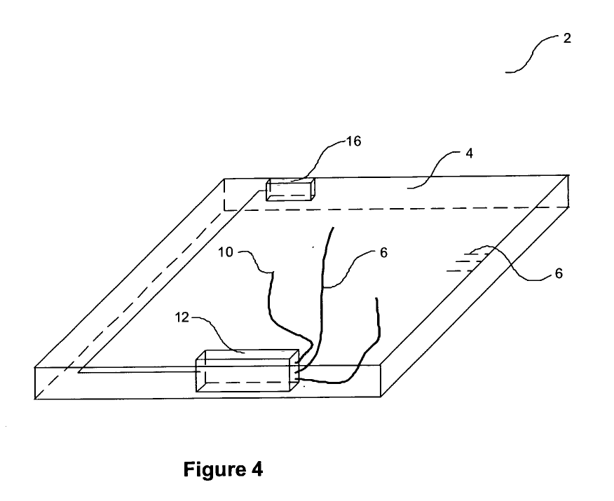

FIG. 4 shows a further embodiment of the illuminating structure 2, which includes a solar cell (16) to power the light source (12). One of skill in the art will readily appreciate that an accumulator for collecting power from the solar cell and powering the light source can be implemented using a simple extension of the above embodiment. FIG. 4 also shows an alternative arrangement of the ends of the optical fibers, so as to create an alternative pattern with the illuminated ends of the optical fibers.

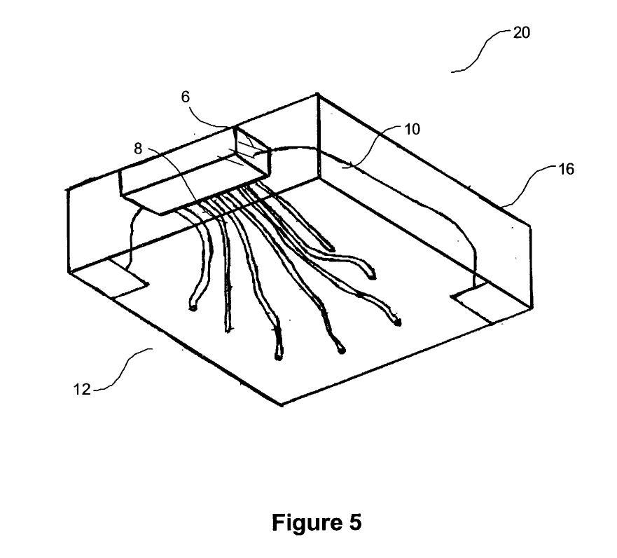

FIG. 5 shows an illuminating structure for illustrative purposes. A tile (20) which may be used as part of a side walk, pedestrian path, patio or indoor floor. The tile optionally further includes a solar cell (16) which may be embedded at a surface for converting solar power into electrical power. One of skill in the art will appreciate that a number of embodiments of the tile are possible, for example, the solar cell may be positioned externally to the structure. Because of the robust nature of the hardening substrate, the tile can withstand the weight of a person, bicycle or a motor vehicle.

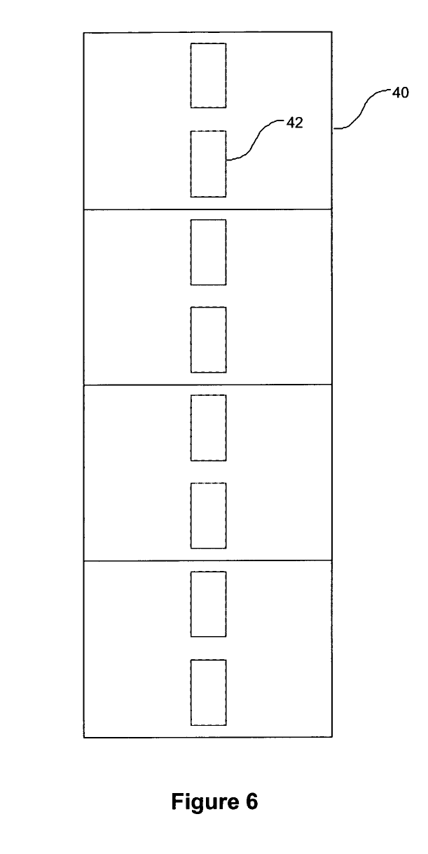

FIG. 6 illustrates an alternative embodiment of the present invention which includes a system of tiles for illuminating a path on a walkway, road, airplane runway. The pattern (42) at the surface of the tile (40) consists of fiber ends arranged to illuminate a path. The surface of the hardening substrate of the tile can be worn out while continuing to function and provide similar illumination, because the fibers are simply worn away flush with the surface.

FIG. 7 illustrates an illuminating structure can be formed as a sign (60) having optical fibers arranged in the pattern of an arrow (62). Of course, other arrangements and patters may be used with the invention, for example an expression, directions, a picture or a number. A sign with an arrow can resist weather conditions by preventing rain, hail, or snow from entering the sign.

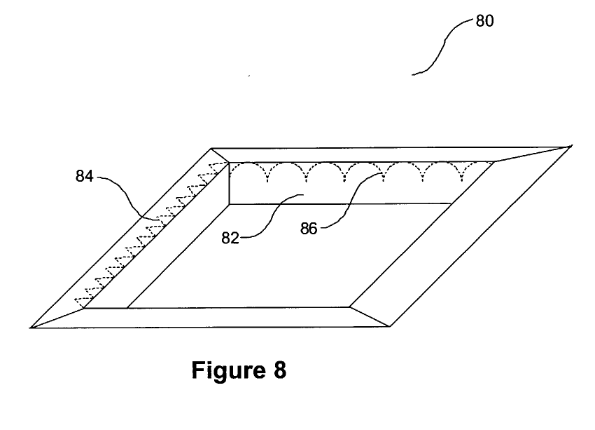

FIG. 8 illustrates an alternate embodiment of the present invention in which the structure is a swimming pool (80) including an illuminating pattern around its edge. At the surface (82), a pattern (86) of fiber ends embedded in the pool provides decorative lighting. In another embodiment, the pattern (84) along the walking edge of the pool provides illumination to decorate but also to guide a person in walking alongside the pool in the dark by lighting a person's path.

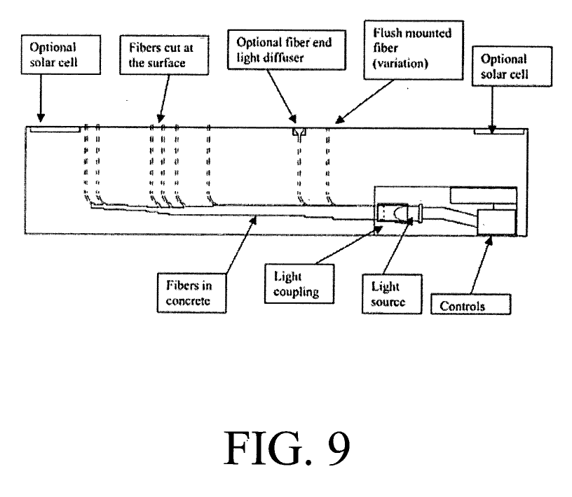

FIG. 9 illustrates a side view in section of an illuminating tile according to an embodiment of the invention. In this embodiment, two solar cells are shown, one at each end of the surface of the tile. Optical fibers originate at a proximal end adjacent a light source having a light coupling. The distal ends of the optical fibers emerge to the upper surface of the tile and are cut so as to be flush with the surface. One of the fibers shown comprises a light diffuser on the end thereof. In the case of this particular fiber, the light diffuser portion of the fiber is flush with the upper surface of the tile. This allows a diffusion of light from the optical fiber over a larger surface area in the illuminated pattern.

FIG. 9 shows fibers embedded in concrete, all of which originate from a proximal end where they are coupled to a light source via a light coupling. The light source, light coupling, and controls are housed within a cavity of the tile formed at the lower end thereof. The solar cells are operatively linked to the light source via the controls through connections not shown. Of course, in other embodiments, the power source used for providing power to the light source may be of any acceptable type and may be housed within the cavity, housed at the surface of the structure, or located remotely from the structure.

FIG. 10 illustrates a schematic view of an illuminating tile with an arrow pattern thereon according to an embodiment of the invention. The front view of the tile surface is shown, as well as a side view in section. As can be seen from the front view, the tile can be used as signage, and could be mounted with the illuminated surface oriented either in a vertical or horizontal plane. If used in a horizontal plane, such as on the floor, the illuminated tile would serve the purpose of directing passage for passers-by, and would have the advantage of being extremely durable, regardless of the type of traffic (pedestrian, bicycle or motor vehicle) passing thereover. If used in a vertical plane, the advantage of durability is also realized, and the tile would advantageously stand up to conditions such as unpredictable weather.

In the embodiment of FIG. 10, the tile has an optical connector for connection with an external light source. In order to form the tile shown in this embodiment, concrete has been poured over an arrangement of fibers such that the fiber end points (the distal ends of each fiber) form the pre-determined pattern of an arrow at the surface of the tile. In this case, fibers originate from the region of the optical connection point. As can be seen from the side view in section, the optical connection point is shown housed within a cavity on a side of the tile structure, and the fibers originate from this cavity. Of course, one of skill in the art would understand that a tile with multiple optical connections could also be used, and that the optical connection point may be external to the structure itself in an embodiment where no cavity was formed.

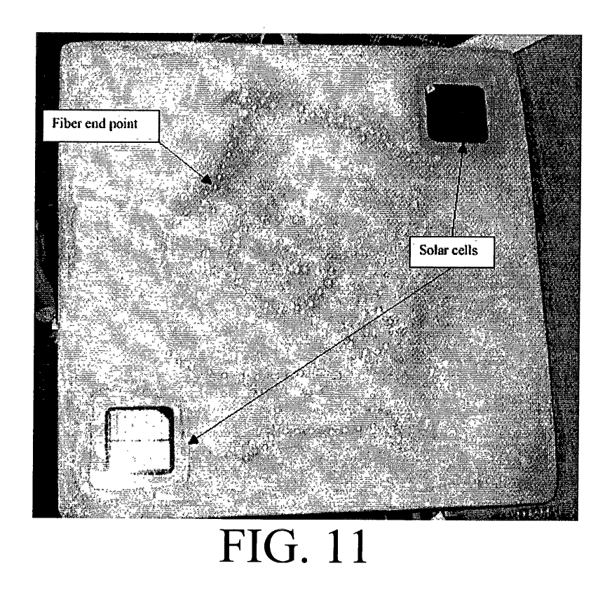

FIG. 11 illustrates a solar-powered illuminating tile having a pattern of cartoon character's face illuminated on the surface thereof according to an embodiment of the invention. The solar cells are located at the illuminated surface of the tile, but away from the pattern of light formed by the fiber ends, so as not to impose on the pattern. However, in an alternative embodiment the solar cells could also be integrated within the per-determined pattern, as desired. In this case, the distal terminal ends of the fibers may show the same or different colors of light, consistent with the desired effect.

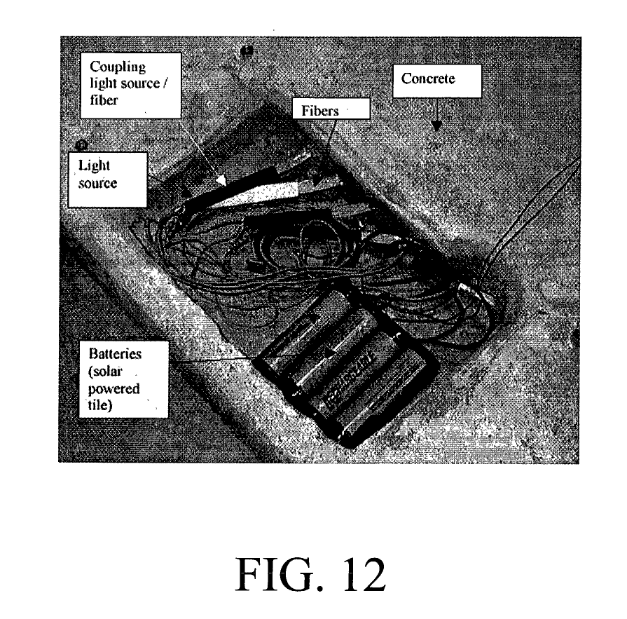

FIG. 12 illustrates a light source embedded in a cavity of a concrete illuminating tile according to an embodiment of the invention, showing optical fibers embedded in the tile. The optical fibers are bundled within the cavity, and beyond the cavity the fibers are embedded in the concrete forming the tile. Couplings are used to connect the fibers with the light source. Connecting wires associate the couplings with the power source, in this case batteries, which are rechargeable. The batteries are connected by wires shown here as external to the structure, to a remote solar cell. The solar cell may be housed within the tile, for example in a separate cavity on the upper surface of the tile (as shown in FIG. 11) or may be external to the tile.

FIG. 13 shows a structure according to the invention having a light source embedded in a flexible irregularly shaped strip. The strip may be formed, for example, out of a resilient material such as soft silica, capable of deformation, but which can flow into a mould to create the illuminated structure, and which subsequently hardens into a flexible form. Distal ends of optical fibers embedded in the strip are shown terminating flush with the surface of the strip.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. An illuminating structure comprising:
a hardened substrate, having at least one surface; and
an optical wave guide through which light is transported, the optical wave guide being embedded in the hardened substrate and having a distal end terminating visibly from the surface of the hardened substrate so that light transported through the fiber is visible on the surface.

2. The illuminating structure of claim 1, wherein the optical wave guide comprises an optical fiber having a light diffuser disposed at a distal end thereof, the light diffuser terminating flush with, recessed in, or protuberant from the surface of the hardened substrate.

3. The illuminating structure according to claim 1 wherein the optical wave guide comprises an optical fiber.

4. The illuminating structure of claim 3, further including a light source for illuminating the optical fiber.

5. The illuminating structure of claim 4, wherein a cavity is formed in the hardened substrate for housing the light source.

6. The illuminating structure of claim 4, wherein the light source is selected from the group consisting of: an incandescent light bulb; a halogen bulb; a fluorescent tube; and a light emitting diode.

7. The illuminating structure of claim 3, wherein the hardened substrate is formed of a substance selected from the group consisting of concrete, cement, epoxy and silicon.

8. The illuminating structure of claim 3, comprising a plurality of optical fibers having a distal end terminating visibly from the surface of the hardened substrate.

9. The illuminating structure of claim 8, wherein the distal ends of the fibers are arranged to form a pattern at the surface of the hardened substrate.

10. The illuminating structure of claim 4, further including a power source for powering the light source.

11. The illuminating structure of claim 10, wherein the power source is selected from the group consisting of a battery and a solar cell.

12. The illuminating structure of claim 1, wherein the structure forms a tile, a sign, a portion of a swimming pool, or a strip.

13. An illuminating structure comprising:
a hardened substrate, having at least one surface; and
an optical fiber through which light is transported, the fiber being embedded in the hardened substrate;
a light diffuser located at a distal end terminal end of a fiber, said light diffuser being exposed at the surface of the hardened substrate so that light transported through the fiber is diffused through the light diffuser and is visible on the surface of the hardened substrate.

14. A method of constructing an illuminating structure comprising the steps of:
holding an optical wave guide in a pre-determined position within a mould;
pouring a flowing hardenable substrate into the mould to cover a portion of the wave guide while leaving an end of the fiber exposed to a surface of the mould; and
allowing the substrate to harden.

15. The method of claim 14, wherein the optical wave guide comprises an optical fiber with a light diffuser disposed at the distal end thereof, located flush with, recessed in, or protuberant from the surface of the mould.

16. The method of claim 14, wherein the optical wave guide comprises an optical fiber.

17. The method of claim 16 additionally comprising the step of truncating the fiber so that the portion of the fiber exposed at a surface of the mould is flush with the surface.

18. The method of claim 16, wherein the step of truncating comprises exposing a surface of the substrate, once hardened, to a grinder.

19. The method of claim 16, wherein the step of holding comprises aligning ends of a plurality of fibers with a stencil having holes located therein to form a pre-determined pattern.

20. The method of claim 16, further including, prior to the step of pouring, the step of forming a cavity within the mould disposed at a proximal end of the optical fiber.
